(19) United States
(12) Patent Application Publication
(10) Pub. No.: US 2004/0200811 A1
(43) Pub. Date: Oct. 14, 2004

(54) Postcombustion removal of n2o in a pulsed corona reactor

(76) Inventors: Temi M Linjewile, Lehi, UT (US); Paolo DeFilippis, Rome (IT); Pradeep K Agarwal, Laramie, WY (US); Rehke Agarwal, Laramie, WY (US)

Correspondence Address: Emery L Tracy, P O Box 1518, Boulder, CO, 80306, US

(21) Appl. No.: 10/479,195

(22) PCT Filed: May 29, 2002
(86) PCT No.: PCT/US02/16812

Related U.S. Application Data
(60) Provisional application No. 60/294,526, filed on May 30, 2001.

(51) Int. Cl. B23K 10/00

(52) U.S. Cl. 219/121.59

(57) ABSTRACT

A method for the removing NO and N₂O from a gas stream is provided. The method comprises providing flue gases having NO and/or N₂O, introducing the flue gas stream into a pulsed corona reactor, and reacting the raw feed gases within the pulsed corona reactor with the following reactions: e+H₂O→H+OH,N₂O+H→N₂+OH, and N₂O+OH→N₂+HO₂. An apparatus for removing NO and N₂O is also provided.

### BACKGROUND OF THE INVENTION

1. Field of the Invention

This invention relates generally to the postcombustion removal of N₂O in a pulsed corona reactor.

2. Description of the Prior Art

Environmental concerns over SOₓ and NOₓ emissions from coal-fired power plants led to the emergence of Fluidized Bed Combustion (FBC) as a viable alternative to burning coal in an environmentally acceptable manner due to the lower NOₓ emissions and optimum conditions for SOₓ removal with limestone or dolomite as sorbents. However, in the FBC operating temperature window formation of N₂O is enhanced, ranging from fifteen (15) to two hundred (200) ppm in comparison to five (5) ppm levels observed in pulverized coal-fired boilers. This raises concern over increased emission levels of N₂O, a potent greenhouse gas and a known agent for depletion of stratospheric ozone layer.

Extensive research has been conducted to understand the effects of operating parameters on N₂O and NOₓ emissions from FBC systems. Operating temperature has been identified as the most profound factor in the destruction of N₂O in FBC of coal. High operating temperature favors thermal decomposition of N₂O leading to minimum emission levels. The current approach to minimizing N₂O emissions is based on raising the combustion temperature. There are problems, however, in operating the FBC at temperatures higher than 900° C. mainly due to increase in NOₓ emissions by the Zeldovitch mechanism and the decrease in SO₂ removal efficiency.

In recent years, many attempts have been made to remove NOₓ and SOₓ from combustion gases using corona discharge reactors. NOₓ removal efficiencies of up to 90% in a system employing a pulsed discharge plasma reactor, catalysts and hydrocarbon gas injection have been reported. The effect of water and ethylene on NOₓ and N₂O removal using a discharge plasma to generate H, OH and CH radicals have been investigated. Although the technique has been applied for control of NOₓ and SOₓ, there are no reported comprehensive studies on N₂O removal chemistry using pulsed corona-induced plasmas.

### SUMMARY

The present invention is a method for the removing NO and N₂O from a gas stream is provided. The method comprises providing flue gases having NO and/or N₂O, introducing the flue gas stream into a pulsed corona reactor, and reacting the raw feed gases within the pulsed corona reactor with the following reactions: e 30 H₂OH+OH, N₂O+H→N₂+OH, and N₂O+OH→N₂+HO₂.

The present invention further includes an apparatus for the removing NO and N₂O from a gas stream. The apparatus comprises a gas stream and a pulsed corona reactor for receiving the gas stream wherein the raw feed gases are reacted within the pulsed corona reactor with the following reactions: e+H₂O →H+OH, N₂O +H→N₂+OH, and N₂O+OH→N₂+HO₂.

### BRIEF DESCRIPTION OF THE DRAWINGS

FIG. 1 is a schematic view illustrating a device for the postcombustion removal of N₂O in a pulsed corona reactor, constructed in accordance with the present invention;

FIG. 2 is a graph illustrating the performance waveforms for reactor voltage and current pulses using 200 ppm N₂O in argon;

FIG. 3 is a graph illustrating the performance waveforms for reactor power and energy pulses using 200 ppm N₂O in argon;

FIG. 4 is a graph illustrating the removal of N₂O in argon for humid and dry gases;

FIG. 5 is a graph illustrating the removal of NO in argon for humid and dry gases;

FIG. 6 is a graph illustrating the removal of N₂O in nitrogen for humid and dry gases;

FIG. 7 is a graph illustrating the removal of NO in nitrogen for humid and dry gases;

FIG. 8 is a graph illustrating the formation of N₂O during destruction of NO in nitrogen; and

FIG. 9 is a graph illustrating the formation of NO₂ during destruction of NO in nitrogen.

### DETAILED DESCRIPTION OF THE PREFERRED EMBODIMENTS

The removal of N₂O and NO by a pulsed corona reactor was investigated. Gas mixtures containing N₂O or NO were allowed to flow in a pulsed corona reactor at various levels of energy input into the reactor. The roles of carbon monoxide and moisture on the removal of N₂O and NO were examined. The reactor effluent gas stream was analyzed for N₂O, NO, NO₂, CO and CO₂ by means of an FTIR Spectrometer and H₂ by a gas chromatograph. It was found that 93% of input N₂O was destroyed in dry argon but only 35% was destroyed in dry nitrogen, and about 90% of NO introduced into the reactor was removed in dry nitrogen whereas only 50% was destroyed in dry argon. The presence of CO in either dry argon or nitrogen hindered the destruction of N₂O but assisted the destruction of NO. A moisture content of about 1.4% was shown to be detrimental to the removal of both N₂O and NO. The hypothesis that in a corona reactor a humid gas will produce H and OH radicals at room temperature and that the OH radicals will oxidize CO, releasing H atoms has been proved. However, under the experimental conditions of this investigation, there is no evidence of subsequent reaction between N₂O and H or OH radicals. The possible mechanisms for the destruction of N₂O and NO and for by-product formation are discussed.

The present invention, indicated generally at 10, uses moisture and CO in the plasma-induced chemistry of N₂O and NOₓ destruction in the flue gas stream of FBC systems using a pulsed corona reactor. Briefly, a high-voltage pulsed corona discharge from the surface of a conductor causes a gas molecule in the intense electric field close to the discharge electrode to lose an electron and become charged. The free electrons generated in the high electric field region are accelerated to high velocities, colliding with neutral gas molecules and creating more free electrons and ions. The process is repeated many times so that an avalanche of energetic electrons is generated within the corona region. The energetic electrons undergo inelastic collisions with the surrounding atoms and molecules. In the process, the electrons lose their energy to the atoms and molecules, thereby causing these species to be excited to higher energy levels. The excited atoms or molecules can either dissociate or initiate other reactions with neighboring species. The electric field replenishes the energy of the electrons over the short mean free path in the gas and the process is repeated all over again.

A plasma is a collection of charged and neutral particles consisting of electrons, ions and neutral molecules. If an electric field is applied to a plasma of low degree of ionization the charged particles, especially the lighter electrons will be energized and the bulk of the massive ions will be unaffected. Because the average electron energy or temperature is much higher than that of the bulk gas molecules, the plasma is referred to as non-thermal or non-equilibrium or a cold plasma. This distinguishes it from a thermal plasma where all the ions and electrons are in thermal equilibrium.

According to the dissociative attachment reaction R1, the breaking of an H atom from water by electron impact forms OH radicals.

e+H₂O→H+OH (R1,)

The homogeneous destruction of N₂O by radical attack occurs following reaction pathways with H and OH radicals as shown below:

N₂O+H→N₂+OH (R2)

N₂O+OH→N₂+HO₂ (R3)

The corona reactor is used as a device for generation of free radicals to promote reactions R2 and R3. In a combustion environment, generation of H and OH radicals from H₂O requires high temperature, which is unfavorable to NOₓ emission control. In a pulsed corona discharge plasma reactor, however, free radicals can be generated at room temperatures without substantially heating up the background gas, because most of the electrical energy supplied selectively goes to accelerating the electrons. Carbon monoxide added to the reactor serves as a source of scavenger molecules for removal of OH radicals as shown in the reaction R4.

CO+OH→CO₂+H (R4)

Reaction R4 is in effect a recycling of H radicals. It is postulated that Reaction R1 in combination with reaction R4 will ensure the sustenance of H radical generation. This will increase the H radical pool leading to increased opportunity for destruction of N₂O via reaction pathway R2. The recycling of H radicals from hydroxyl radicals will result in improvement in power consumption of the process.

### Experimental Technique

### The Pulsed Corona Reactor and the Generation of a Non-Thermal Plasma

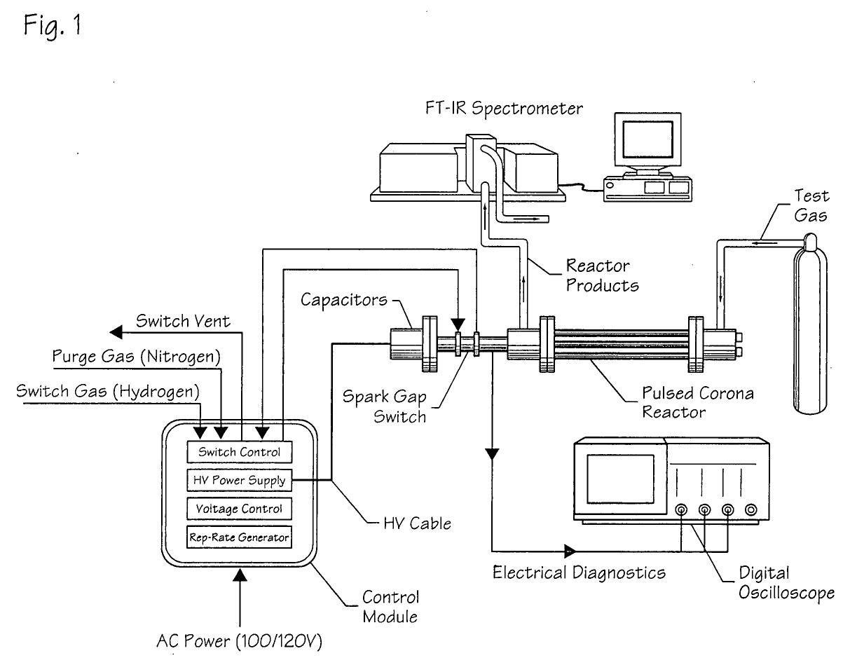

A pulsed corona reactor (PCR) has been designed and constructed to allow gas mixtures of various compositions to be tested. The design permits the varying and measurement of capacitor charging voltage and its frequency, reactor current and voltage, and calculation of discharge power and energy. A schematic diagram of the experimental set-up is illustrated in FIG. 1. The PCR System consists of a high-voltage power supply and control unit and the pulser/reactor assembly. Table 1 shows the specifications of the reactor and pulser units.

The high voltage controller consists of electronic and gas controls required to

regulate the high voltage charging power supply as well as the pulsed power delivered to the reactor gas. The pulser/reactor assembly contains the pulsed power generator and the pulsed corona discharge reaction chambers. These two sub-units are connected by a high voltage cable for charging the capacitors in the pulsed power generator and by high-pressure hydrogen gas lines for controlling the voltage delivered to the reactor. The corona reactor consists of ten (10) parallel reaction tubes and is fitted with UV-grade quartz windows for diagnostics and plasma observation. The high voltage supply in the control cabinet charges discrete capacitors located inside the pulser subassembly. Once the voltage on the capacitors is sufficiently high, a high-pressure hydrogen spark gap switch located in the pulser closes, connecting the capacitors to the reactor anodes. The high-voltage pulses applied to the reactor create a very intense electric field around the wire anodes which ionizes the gas molecules near it creating a plasma. The energy from the capacitors is then discharged very quickly into the plasma, and once all the stored energy is dissipated in the plasma the discharge stops.

### Experimental Procedure

Experiments were conducted in argon and nitrogen environments. The test gases consisted of mixtures of either two hundred (200) ppm N₂O or six hundred (600) ppm NO in argon or nitrogen. Some of the gas mixtures also consisted of one (1%) percent CO. In experiments where moisture was added, the standard gas mixture was allowed to flow through a humidifier-prior to entering the PCR. The test gas mixture kept at room temperature, flowed through the PCR at the rate of 47.2 lit/min and the residence time of the gas in the reactor was about two (2) seconds. Depending on the power supplied to the reactor, the steady-state gas temperature at the reactor exit ranged from room temperature to sixty (60° C.) degrees Celsius. Gas samples were collected from the discharge end of the PCR in small Whitey stainless steel cylinders of one hundred and fifty (150 ml) milliliters capacity. The gas samples were then analyzed for stable species formed and destroyed by means of a Perkin. Elmer Spectrum 2000 FTIR Spectrometer with a narrow band MCT detector. The spectral resolution was set at 0.5 cm⁻¹. The gas cell used for analysis was a Foxboro LV7 variable path-length multi-pass low volume (223 ml) cell. The path-length could be varied from 0.25-7.25 m. In the experiments described, the path-length was set at 7.25 m. The instrument was calibrated for N₂O, NO, NO₂, CO and CO₂. Hydrogen gas was measured using a Hewlett Packard 5890 Series II gas chromatograph.

The charge voltage to the capacitors, the reactor voltage and current pulses were measured using a four-channel Tektronix TDS 784D 1 GHz digital oscilloscope, capable of sampling at 4GS/s. In order to cope with the fast-changing reactor voltage and current which show typical pulse widths of fifteen (15) to thirty-five (35) nsec wide with risetimes of five (5) nsec for air, the minimum requirement of the oscilloscope is a bandwidth of five hundred (500) MHz. The corona power was calculated from the product (VI) of the measured pulse voltage and current. The energy is the time integral (∫VI dt) of power.

### Results and Discussion

### Voltage and Current Waveforms

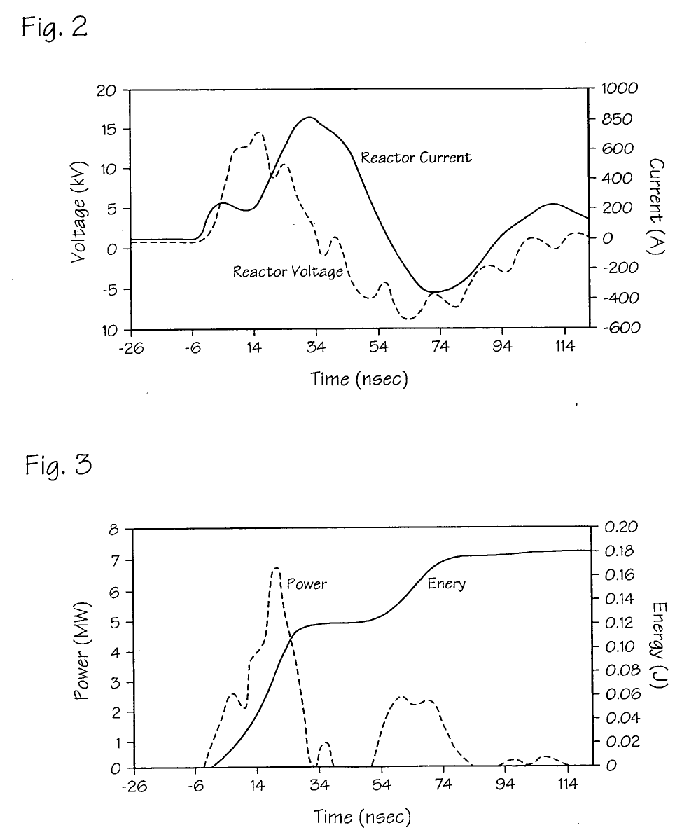

An inference of the performance of the corona reactor can be made from the pulse voltage and current waveforms. FIG. 2 illustrates typical measured voltage and current pulse waveforms for a dry gas containing two hundred (200) ppm N₂O in argon. The pulsed voltage had an extremely fast rise time of about fifteen (15) nsec, a peak voltage of 15 kV and a pulselength of about 70 nsec. The peak current was about 800A. When the corona reactor is started, the high-voltage power supply charges the pulse forming capacitors at a specified frequency. The capacitors discharge rapidly into the reactor through a spark gap giving the short voltage rise time required. The waveform shows two current pulses. The first pulse with a peak value of about 200A occurred during the rising part of the voltage pulse. This represents the current through the reactor caused by the charge released by the capacitors. The second current pulse occurring during the falling part of the voltage pulse is due to the presence of electrons and ions, indicating that an intense plasma has been formed. Pulsing of the voltage and current allows energy to be deposited in the gas in a highly concentrated form. This is illustrated in FIG. 3 where the peak reactor power and energy pulses are about 7 MW and 0.2 J respectively.

The short rise time and pulselength have the advantage of generating energetic electrons with only a limited movement of the ions. In such a system, the mean electron energies or temperature is much higher than that of the bulk gas molecules. Thus the waveforms confirm that the nonthermal condition has been reached. As a consequence of the nonthermal condition, higher voltage pulses and hence higher electric fields can be applied above the corona inception value in the short duration of a pulse without causing a spark to bridge the gap between the electrodes in the reactor. The rapidly extinguishing electric field stops electrons between successive pulses from being accelerated to the anode and also prevents much heavier ions from gaining sufficient energy to make a transition to the spark or thermal plasma condition. If the current waveform shows underdamped oscillations, the reactor is sparking and the run is stopped immediately. Sparking also produces unmistakable sounds.

### Reactions in Argon

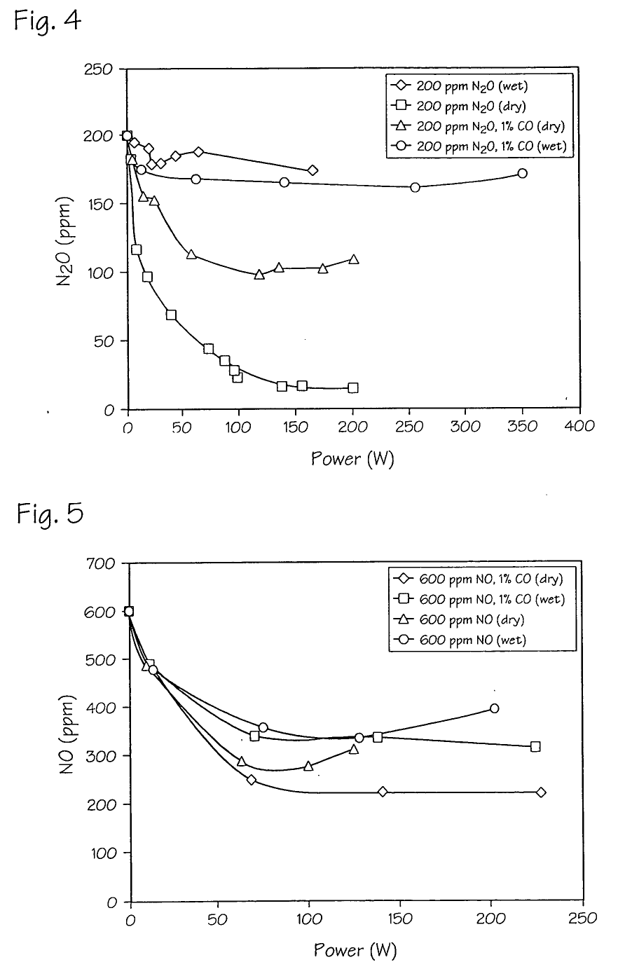

A gas mixture containing two hundred (200) ppm N₂O in dry argon was tested in the PCR. The experimental variables are shown in Table 2. The results for this experiment are presented in FIG. 4. It is illustrated in FIG. 4 that removal of N₂O increases as the energy is increased. Up to ninety-three (93%) percent of the N₂O introduced in the reactor was destroyed. It is also noteworthy that the maximum temperature of the gas leaving the reactor was only thirty-four (34° C.) degrees Celsius. The destruction of N₂O may be explained by the following electron-impact dissociation reactions.

e+N₂O→N₂+O+e (R5)

e+N₂O→N₂+O(^{|}D)+3 (R6)

e+N₂O→N₂(A)+O+e (R7)

In other tests with N₂O, the effects of moisture and CO addition were investigated. As illustrated in FIG. 4, less N₂O was destroyed in a dry gas containing one (1%) percent CO. Even less N₂O was destroyed in the presence of both moisture and CO. It was determined analytically that in the presence of moisture, CO was converted to CO₂ and hydrogen was formed. It is clear from these observations that the proposed hypothesis holds for reaction (1) and (4). As seen in FIG. 4, the conversion of N₂O in argon is seriously limited in humid gas even in the presence of CO. This is puzzling, especially given that H₂ gas was formed. It was expected that H radicals—presumably formed by electron impact of H₂O, would enhance destruction of N₂O. A possible explanation is that the hydrogen radicals recombined rapidly allowing no time for reaction 2 to take place.

The above tests were repeated with a dry gas containing six hundred (600) ppm NO in argon. FIG. 5 illustrates that in a dry gas about fifty (50%) percent of NO was removed. In a dry gas containing six hundred (600) ppm NO, one (1%) percent CO in argon, approximately sixty-six (66%) of NO introduced to the reactor was destroyed. Less NO, however, was destroyed in humid gas.

### Reactions in Nitrogen

A gas mixture containing two hundred (200) ppm N₂O in dry nitrogen was tested. The results are presented in FIG. 6. It is illustrated in FIG. 6 that up to thirty-five (35%) percent of the N₂O introduced in the reactor was destroyed. It is also apparent that a dry gas containing one (1%) percent CO in nitrogen showed higher removal of N₂O than a wet gas with or without CO addition. In experiments with CO addition, CO₂ was formed.

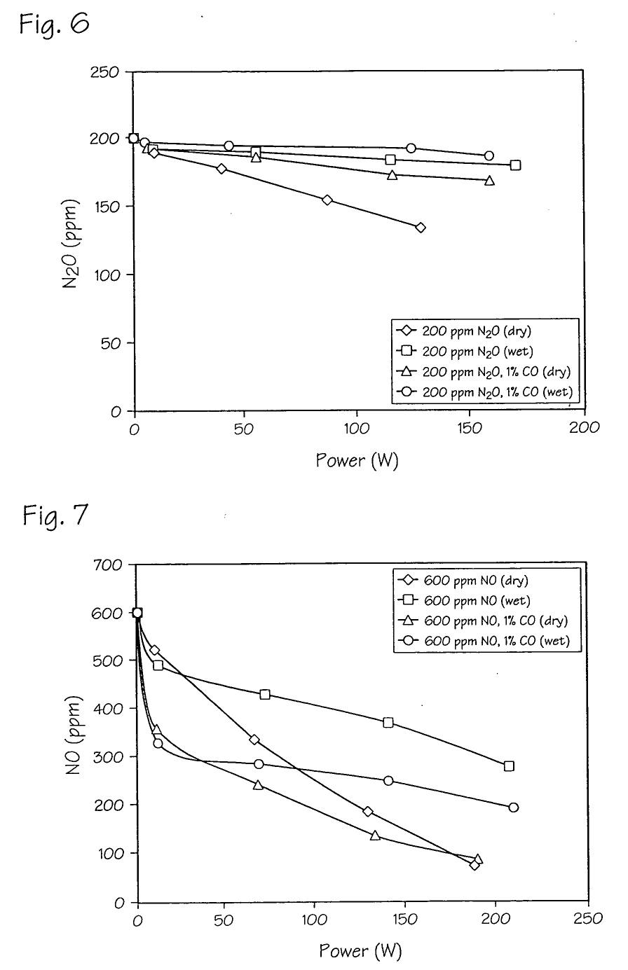

A test gas containing six hundred (600) ppm NO in dry nitrogen was introduced to the corona reactor. A plot of initial NO concentration as a function of energy input to the reactor is presented in FIG. 7. The graph illustrates that in a dry gas about eighty-five (85%) percent of NO introduced to the reactor was removed. Addition of one (1%) percent CO to the dry gas showed significant improvement in removal of NO at low reactor energy. The gap in NO removal between addition of 1% CO and without CO seems to narrow as energy is increased. In a humid gas, more NO was removed when 1% CO was added to the gas. However, NO removal was only about fifty (50%) percent. As in the previous cases, addition of CO in humid gas also resulted in formation of CO₂, indicating that oxidation of CO by OH radicals occurred. The destruction reactions of NO in nitrogen are thought to follow the reaction pathways shown below.

e+N₂→N+N+e (R8)

N+NO→N₂O (R9)

N+OH→NO+H (R10)

NO+OH+M→HNO₂+M (R11)

NO+H+M→NHO+M (R12)

### Formation of By-Products

In experiments for the destruction of N₂O in the plasma reactor, there were no by-products of oxides of nitrogen detected in all cases. The same is true for the destruction of NO in argon. However, destruction of NO in nitrogen resulted in the formation of not only N₂O but also NO₂ as by-products. FIG. 8 illustrates the formation of by-product N₂O. This increased as the reactor-input energy was increased. The results show that dry gas produced less by-product N₂O than wet gas. Further, in wet gas, most N₂O was produced when CO was introduced in the reactant gas mixture.

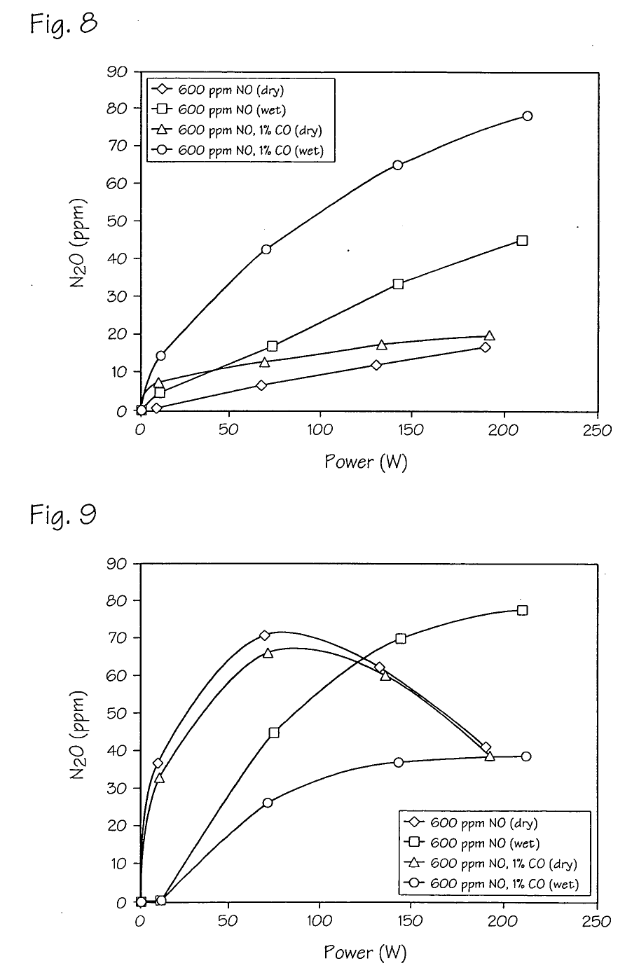

FIG. 9 illustrates the formation of by-product NO₂. The graph shows that for dry gas, NO₂ formation increases with increase in reactor energy input to a peak value, after which it drops as energy is increased. Moreover, for dry gas, the level of NO₂ formation is about the same whether CO is added or not. With wet gas, however, NO₂ production increases with increase in reactor energy input and then it appears to level off. Formation of NO₂ may be due to the following reactions.

NO+O+M→NO₂+M (R13

NO+HO₂→NO₂+OH (14)

In a dry gas, oxygen atoms are furnished by reaction R9 and sustain reaction R13. A wet gas is also a source of the hydroperoxyl radical responsible for reaction R14. It is also noted that addition of CO in the wet gas appears to produce the least amount of by-product NO₂.

### Conclusion

The removal of N₂O and NO in a pulsed corona reactor has been investigated. The hypothesis that in a humid gas H and OH radicals will be formed at room temperature and that the OH radicals will oxidize CO whereby releasing H atoms has been proved. However, under the experimental conditions of this investigation, there is no evidence of subsequent reaction between N₂O and H or OH radicals. The removal of N₂O was highest in argon, whereas that of NO was highest in nitrogen.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

TABLE 1
Reactor and High Voltage System Specifications
HV Power Supply and Pulse Parameters

| | |
|---|---|
| Capacitance | Adjustable in 400 pF increments to 1600 pF |
| Charge Voltage | Adjustable to 28 kV maximum |
| Repetition Rate | Adjustable to 2 kHz |
| Maximum power into | Greater than 1 kW at 1600 pF, 2 kHz, 28kV and |
| reactor gas | 170 SLM air flow rate |
| Power Pulse Width | Less than 15 nsec FWHM (at 400 pF, 28 kV, 2 |
| | kHz and 45 SLM air flow rate |

Spark Gap Switch

| | |
|---|---|
| Switch gas | Hydrogen, 41 atm supply |
| Purge gas | Nitrogen, 27 atm supply |
| Switch Operating | 34 atm maximum |
| Pressure | |

Reactor Construction

| | |
|---|---|
| Configuration | 10 coaxial wire-in-tube reaction chambers with |
| | common inlet and exhaust gas manifolds |
| Reaction chamber | 22.9 mm ID; 915 mm long |
| dimensions | |
| Materials of | 304 stainless steel, teflon |
| construction | |
| O-rings | Viton |
| Corona wire | 0.5 mm diameter (stainless steel) |
| Viewing Ports | UV-grade quartz windows configured axially, |
| | radially and in code view |

TABLE 2
Experimental Conditions
HV Power Supply and Pulse Parameters

| | |
|---|---|
| Capacitance | 800 pF |
| Charge Voltage | 25 kV |
| Charge Voltage Frequency | 50-1500 Hz |

Spark Gap Switch

| | |
|---|---|
| Switch Gas | Hydrogen, 41 atm supply |
| Purge Gas | Nitrogen, 27 atm supply |
| Switch Operating Pressure | 27 atm |

Reactor Operating Conditions

| | |
|---|---|
| Configuration | 4 active coaxial wire-in-tube |
| | reaction chambers |
| Gas Flow Rate | 47.2 lit/min |
| Residence Time | 2 sec |
| Inlet Gas Pressure | 1.4 atm |
| Outlet Gas Pressure | 1.2 atm |
| Inlet Gas Temperature | 21° C. |
| Outlet Gas Temperature | 22-60° C. |
| Test Gases | 200 ppm N₂O, 600 ppm NO |
| Balance Gases | Argon, Nitrogen |
| Added Gases | 1% CO, 1.4% Moisture |

What is claimed is:

1. A method for the removing. NO and N₂O from a gas stream, the method comprising:
providing flue gases having NO and/or N₂O;
introducing the flue gas stream into a pulsed corona reactor; and
reacting the raw feed gases within the pulsed corona reactor with the following reactions:
e+H₂O→H+OH;
N₂O+H→N₂OH; and
N₂O+OH→N₂O+HO₂,

2. The method of claim 1 and further comprising:
producing a high-voltage pulsed corona discharge within the pulsed corona reactor;
causing gas molecules within the flue gases to lose an electron creating free electrons;
charging the free electrons;
accelerating the free electrons to high velocities;
colliding the free electrons with neutral gas molecules; and
creating additional free electrons and ions.

3. The method of claim 2 and further comprising:
colliding the energized electrons with surrounding atoms and molecules;
exciting the energized electrons to higher energy levels;
dissociating the excited atoms or molecules or initiating other reactions with neighboring species; and
replenishing the energy of the electrons with the electric field over the short mean free path in the gas.

4. The method of claim 1 wherein the pulsed corona reactor is selected from the group consisting of a non-thermal pulsed plasma corona and a silent discharge reactor.

5. The method of claim 1 wherein the flue gases are collected from coal emissions.

6. The method of claim 1 and further comprising:
generating free radicals at room temperatures.

7. The method of claim I and further comprising:
adding carbon monoxide to the pulsed corona reactor initiating the following reaction:
CO+OH→CO₂+H.

8. An apparatus for for the removing NO and N₂O from a gas stream, the apparatus comprising:
a gas stream;
a pulsed corona reactor for receiving the gas stream;
wherein the raw feed gases are reacted within the pulsed corona reactor with the following reactions:
e+H₂O→H+OH;
N₂O+H→N₂+OH; and
N₂O+OH→N₂+HO₂.

9. The apparatus of claim 8 wherein a high-voltage pulsed corona discharge is produced within the pulsed corona reactor causing gas molecules within the flue gases to lose an electron creating free electrons and charging the free electrons, the free electrons being accelearated to high velocities and colliding with neutral gas molecules thereby creating additional free electrons and ions.

10. The apparatus of claim 9 wherein the energized electrons collide with surrounding atoms and molecules thereby exciting the energized electrons to higher energy levels, dissociating the excited atoms or molecules or initiating other reactions with neighboring species, and replenishing the energy of the electrons with the electric field over the short mean free path in the gas.

11. The apparatus of claim 8 wherein the pulsed corona reactor is selected from the group consisting of a non-thermal pulsed plasma corona and a silent discharge reactor.

12. The apparatus of claim 8 wherein the flue gases are collected from coal emissions.

13. The apparatus of claim 8 wherein free radicals are generated at room temperatures.

14. The apparatus of claim 8 wherein carbon monoxide is added to the pulsed corona reactor initiating the following reaction:
CO+OH→CO₂+H.
